(19) United States
(12) Patent Application Publication
(10) Pub. No.: US 2021/0026935 A1
(43) Pub. Date: Jan. 28, 2021

(54) HIGH PERFORMANCE COMPUTE IP ENCRYPTION USING UNIQUE SET OF APPLICATION ATTRIBUTES

(71) Applicant: ENVISTACOM, LLC, Atlanta, GA (US)

(72) Inventors: Michael GEIST, Huntersville, NC (US); Michael BEELER, Jefferson, MD (US); Kasra TOYSERKANI, Rockville, MD (US); Cris MAMARIL, Mesa, AZ (US)

(21) Appl. No.: 16/938,761

(22) Filed: Jul. 24, 2020

Related U.S. Application Data
(60) Provisional application No. 62/878,669, filed on Jul. 25, 2019.

(51) Int. Cl. G06F 21/12; G06F 21/76; G06F 21/10; H04L 9/06; H04L 9/08

(52) U.S. Cl. CPC G06F 21/125; G06F 21/76; G06F 2221/0724; H04L 9/0631; H04L 9/0891; G06F 21/105

(57) ABSTRACT

A system and method within a High-Performance Computing (HPC) environment is disclosed, providing the ability to securely license and protect HPC applications targeting heterogenous compute architectures by leveraging unique identifiers. The system and method securely licenses and protects HPC applications via a method to jointly encrypt a Host code and Kernel code using one of the unique identifiers described above such as the FPGA manufacturer's Chip ID embedded within an FPGA device.

### CROSS-REFERENCE TO RELATED APPLICATIONS

This application claims priority to U.S. Provisional Application No. 62/878,669, filed 25 Jul. 2019. The disclosure of the priority application is incorporated in its entirety herein by reference.

This application also is related to PCT/US20/043545, filed 24 Jul. 2020, the content of which is incorporated herein by reference in its entirety.

### BACKGROUND

Securing Intellectual Property (IP), whether it is one's own IP or that of a customer, or whether its source codes or binary codes that can be reverse-engineered, is a critical function to prevent copying, duplicating, or reverse engineering of a company's intellectual property. This is particularly important for software applications that can be hosted on general purpose commercially available off the shelf (COTS) personal computers (PC), servers, or as a cloud computing application targeted for public data centers. In addition, companies and organizations are tasked with hosting third party applications on their platforms and there is a need to license and protect these applications on the host platform. Many methods of licensing and copyrighting exist in the current art but these methods have several shortcomings. For example, lack of a unique fingerprint-like attribute that could be utilized to prevent replication and spoofing.

A common method for licensing is to associate a particular instance of an application with a particular hardware instance using a Media Access Control (MAC) address of a network device. The MAC address is, by design, unique since it is used to resolve Internet Protocol Addresses within and between networks. The MAC address is programmed by a manufacturer into a network device. The address is stored in hardware through a Read Only Device, or through a firmware mechanism. Regardless of which method is used, this programmability has been exploited by hackers to spoof the licensing methods that use MAC address since the MAC address is easily cloned.

Furthermore, many of these methods for licensing and copyright protection do not address reverse engineering. As PCs and servers are becoming ever so more powerful with integrated hardware acceleration, the applications for such heterogenous computing environment are becoming multi-component, which includes the Host Code being executed on a CPU and Kernel code targeted for various hardware acceleration technologies. Such heterogenous and powerful compute architectures are called High Performance Compute (HPC) devices. They could utilize Graphic Processing Units (GPU), Digital Signal Processors (DSP), or Field Programmable Gate Array (FPGA). Of the various hardware acceleration devices, the FPGA is one of the newest additions to the HPC architecture and offers the highest Performance/Watt. HPCs are becoming prevalently used in private or public data centers for high compute applications, such as Artificial Intelligence, Deep learning, Financials, Data Analytics, search engines, video processing, and cryptography. For such multi-component applications, it is also imperative that all components of an HPC application from the Host Code to the Kernel code netlists are all properly encrypted for an additional layer of security and protection from reverse engineering. There are many known methods to reverse engineer the host code executable, for example using debuggers and disassemblers. These methods could expose important algorithms or trade secrets or infringe on the holder of a copyright. Similar methods exist for reverse engineering a Kernel code netlist, such as an FPGA netlist. A Kernel code netlist is the output of a compiler that takes high-level programming code, such as C/C++, and generates a configuration bit stream for that acceleration device. Simple methods to prevent FPGA reverse engineering such as flattened netlist or even obfuscation are not immune to one with sophisticated reverse engineering tools.

The invention here is directed to a system and method within a High-Performance Computing (HPC) environment and provides a novel approach to securely license and protect HPC applications targeting heterogenous compute architectures. The system and method described leverages unique identifier (i.e. manufacturer serial number) that have now become available in such heterogenous compute environments. A heterogenous architecture is comprised of at least one or more processor cores to optimize performance and energy efficiency by appropriating computations matched to the type of processor available. These cores can be, but are not limited to, a general-purpose CPU, Graphics Processing Units (GPU), or Field Programmable Gate Arrays (FPGA's). Within each processing core of a heterogenous compute architecture, manufacturers will typically embed some form of unique identifier similar to the MAC address. However, unlike the MAC address, there are no known methods to spoof these chip-based unique identifiers. This is because the MAC addresses are typically stored in non-volatile memory devices. In contrast, unique identifier such as the manufacturer serial number of an FPGA device is embedded into the silicon and not modifiable. Thus, such unique identifiers pertaining to the hardware accelerators in a HPC architecture lend themselves as better options to accommodate licensing and protection.

The present invention securely licenses and protects HPC applications via a method to jointly encrypt a Host code and Kernel code using one of the unique identifiers described above such as the FPGA manufacturer's Chip ID embedded within an FPGA device.

Providers of intellectual property (licensor) expect to be compensated for the use of their intellectual asset and it is in their interest to prevent unauthorized use of their material through various techniques and methods. However, there are economic rewards for circumventing such methods to cheat content providers. In many instances, the methods used to secure intellectual property must evolve as countermeasures to circumvent them adapt to the methods.

It is the objective of this invention to provide a method for licensing and securing Intellectual Property to a licensee of the Intellectual Property. The Intellectual Property being protected is HPC type application leveraging at least one FPGA-based hardware accelerator.

It is also an objective of this invention to provide a system for licensing and securing Intellectual Property to a licensee of Intellectual Property. The Intellectual Property being protected is HPC type application leveraging at least one FPGA-based hardware accelerator.

These objectives are accomplished by the various aspects of the invention that uses multiple factors to create a license and protect the licensed material using an executable file, an FPGA netlist, or Kernel Code netlists, and a unique Chip ID associated with one of the FPGA devices. The present disclosure covers the steps required to accomplish the encryption of a high-performance computing (HPC) application using these factors as part of the method for licensing and protection of the application.

### BRIEF DESCRIPTION OF THE SEVERAL VIEWS OF THE DRAWINGS

For a further understanding of the nature, objects, and advantages of the present disclosure, reference should be had to the following detailed description, read in conjunction with the following drawings, wherein like reference numerals denote like elements.

FIG. 1 illustrates the prior art of a particular implementation of a licensing method using a MAC address of a network device. The MAC address is provided by the licensee to the licensor who then uses a License File Generator to create a license file. The generated license file is provided to the licensee to save on the host machine running the application. A software process (also provided by the licensor) running on the host machine compares the generated license file with the MAC address of the host machine. If the generated license file agrees with the MAC address used to create it, then the software application is allowed to execute. If the generated license file does not agree with the MAC address used to create it, the software application terminates and is not allowed to execute. Also, note that the prior art mechanism does not provide any means of security against potential reverse engineering of multi-component application (i.e. HPC applications).

FIG. 2 illustrates a preferred embodiment of the security method (encryption process) of the present invention. All of the components in FIG. 1 are present but in this embodiment, additional factors are used. To guarantee uniqueness, a Chip ID embedded within each FPGA device is used as a factor. The Chip ID is guaranteed to be unique and is nonmodifiable as it is embedded within the FPGA silicon. The Chip ID is read from the FPGA device using a License Manager utility and an appropriate Board Support Package (BSP) and an Application Programming Interface to expose this unique identifier. The extracted Chip ID is then concatenated with the host code netlist, the FPGA netlist, and possibly other Kernel code netlists constituting the HPC application. The concatenated HPC application is encrypted with a strong encryption algorithm, such as the Advanced Encryption Standard (AES) Cipher Block Chaining (CBC) algorithm with a 256-bit key and a 128 bit Initialization Vector (IV), to create a single encrypted code space. The 256-bit key and the 128-bit IV are both randomly generated, stored, and maintained by the licensor. To further enhance security, the key and IV can roll over every time the HPC application code is updated.

FIG. 3 illustrates a preferred embodiment of the decryption process (and runtime) of the present invention. The decryption begins every time the user attempts to execute the HPC application. Every time, the License Manager utility will first read the Chip ID embedded within the FPGA device using the appropriate BSP and API. A strong decryption algorithm, such as AES-256 CBC, then decrypts the first the Chip ID of the encrypted code space and compares this with the Chip ID read by the license manager. If the value matches, then the License Manager proceeds to decrypt the combined host code, FPGA netlist file, as well as, other possible kernel code netlists for other devices within the system. The host code is then launched, the FPGA is configured with the decrypted netlist, and other devices is programmed with their respective decrypted configuration bit stream.

FIG. 4 illustrates a preferred embodiment of the encryption process of the present invention using AES-256 in CBC with a 256-bit secret key and 128-bit IV.

FIG. 5 illustrates a preferred embodiment of the decryption process (and runtime) of the present invention using AES-256 in CBC with a 256-bit secret key and 128-bit IV.

FIG. 6 illustrates a preferred embodiment of the encryption process of the present invention where there is more than one FPGA device, as well as, other acceleration technology device types such as GPU or DSPs that may be present (encryption of application with multiple kernel code). In this case, any one of the FPGA device Chip IDs can be used to uniquely identify the HPC system.

FIG. 7 illustrates a preferred embodiment of the decryption process of the present invention where there is more than one FPGA device, as well as, other acceleration technology device types such as GPU or DSPs that may be present (decryption of application with multiple kernel code). In this case, any one of the FPGA device Chip IDs can be used to uniquely identify the HPC system.

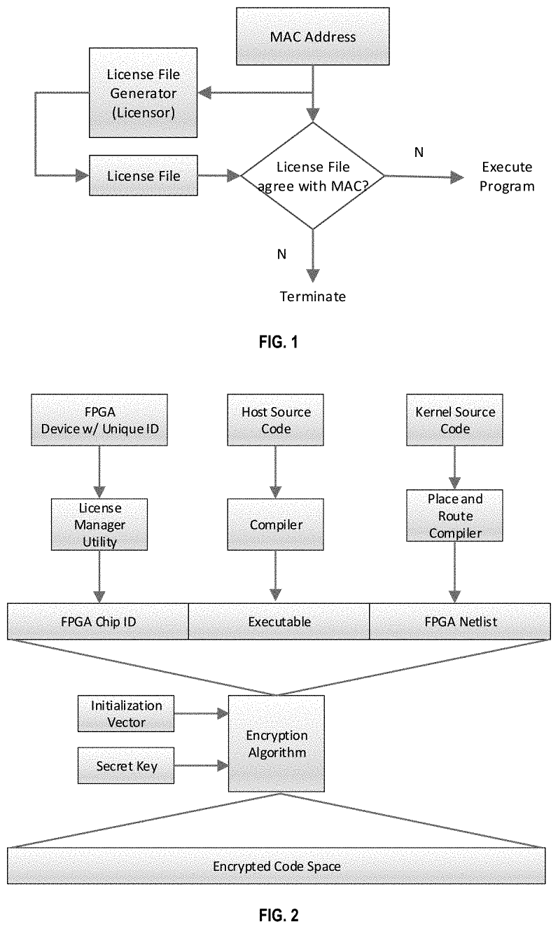

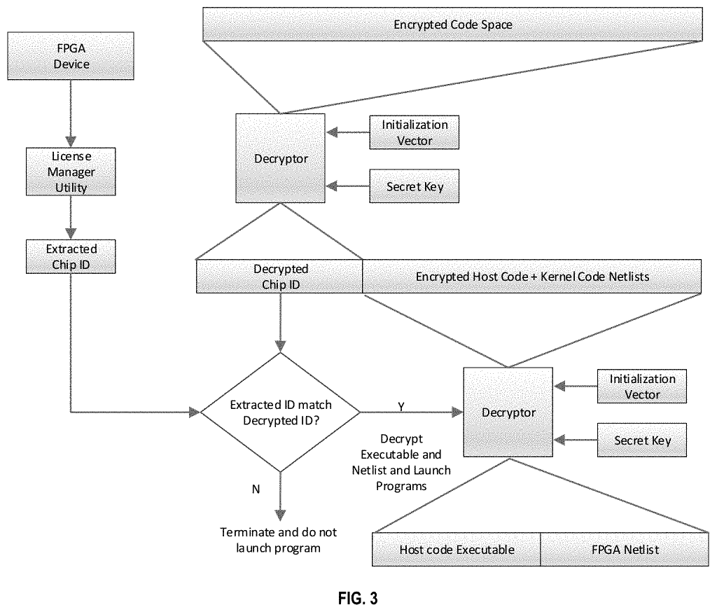

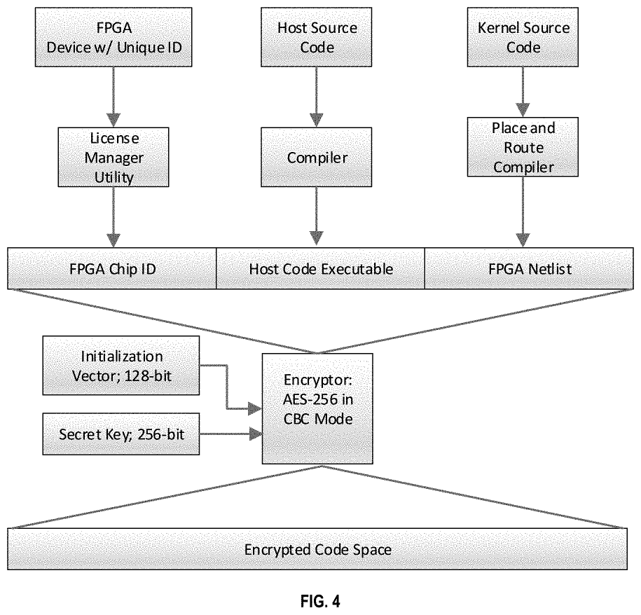

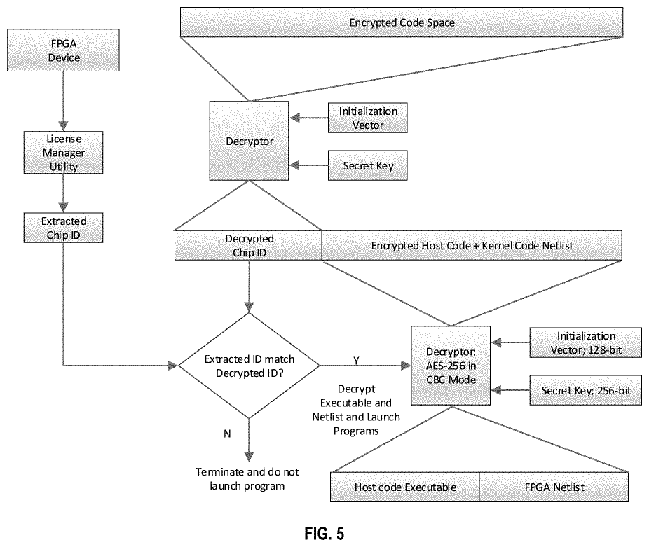

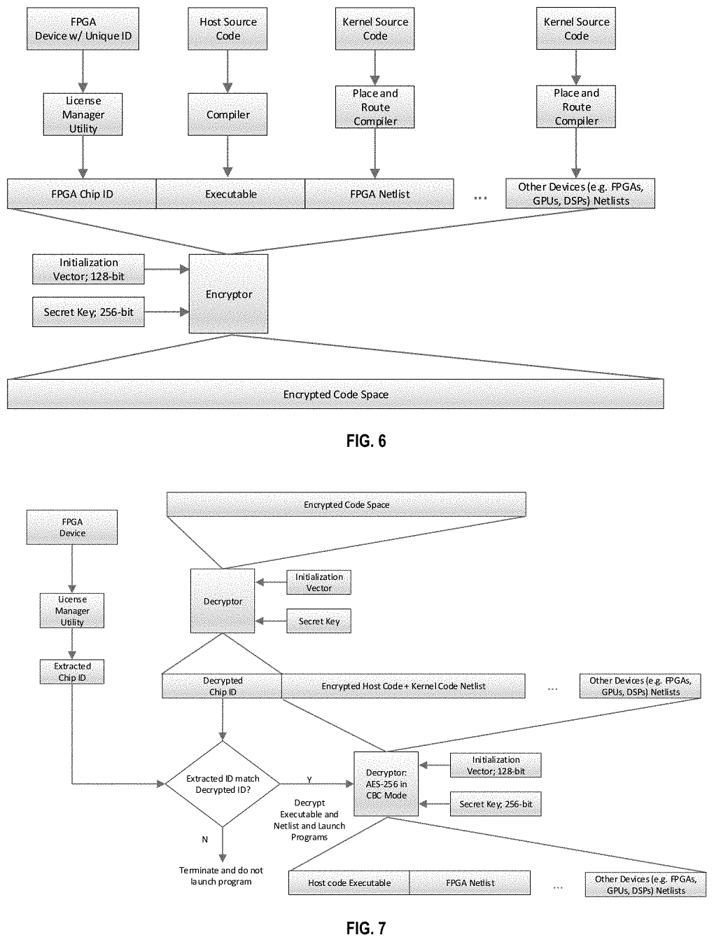

At the outset, it should be appreciated that like drawing numbers on different drawing views identify identical structural elements of the invention. It also should be appreciated that figure proportions and angles are not always to scale in order to clearly portray the attributes of the present invention.

### DETAILED DESCRIPTION

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

This disclosure, its aspects and implementations, are not limited to the specific processing techniques, components, word/bit widths, or methods disclosed herein. Many additional components and processes known in the art consistent with the modification, manipulation and encryption and decryption of a file or files by a computer program are in use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

Particular implementations of a method/approach within an HPC architecture of how to securely license and protect applications via an encryption and decryption scheme for the host code and kernel code utilizing the manufacturer's serial number embedded uniquely in every FPGA device is disclosed. However, as will be clear to those of ordinary skill in the art from this disclosure, the principles and aspects disclosed herein may readily be applied to any licensing and encryption scheme for protecting applications without undue experimentation.

The following are particular implementations with the HPC application security scheme and the use of these methods are provided as non-limiting examples.
1. A licensor requires to secure and protect a Virtualized Modem HPC application targeting an environment consisting of a CPU and an Intel FPGA. Using the described invention, a 64-bit manufacturer serial number or Chip ID embedded in the FPGA is read by the License Manager Utility. This utility implements the Chip ID FPGA logic as part of the OpenCL compliant BSP to make this embedded serial value accessible. The license manager using a host API reads out this value. This unique 64-bit Chip ID value is then used to encrypt to concatenation of the 64-bit Chip ID value, the Host Code executable for the CPU, and the Kernel Code netlist for the Intel FPGA. The entire code space is then encrypted with a secret key and IV to generate the secured virtual modem application.
2. A licensee requires to launch an encrypted Virtual Modem HPC application targeting an environment consisting of a CPU and an Intel FPGA. At run time, the License Manager utility accesses and reads the unique 64-bit value. It then proceeds to decrypt the first 64-bits of the encrypted code space to expose the 64-bit Chip ID. It then compares the two values. The values match, and it then proceeds to decrypt the host code executable for the CPU and the kernel code netlist for the FPGA. The application is then successfully launched.
3. A licensor requires to secure and protect an Artificial Intelligence (AI) HPC application targeting an environment consisting of a CPU and a Xilinx FPGA and a GPU. Using the described invention, a 64-bit manufacturer serial number or Chip ID embedded in the FPGA is read by the License Manager Utility. This utility implements the Chip ID FPGA logic as part of the OpenCL compliant BSP to make this embedded serial value accessible. The license manager using a host API reads out this value. This unique 64-bit Chip ID value is then used to encrypt the concatenation of the 64-bit Chip ID value, the Host Code executable for the CPU, and the Kernel Code netlists for the Xilinx FPGA and the GPU. The entire code space is then encrypted with a secret key and IV to generate the secured AI HPC application.
4. A licensee requires to launch an encrypted AI HPC application targeting an environment consisting of a CPU, a Xilinx FPGA, and a GPU. At run time, the License Manager utility accesses and reads the unique 64-bit value from the FPGA. It then proceeds to decrypt the first 64-bits of the encrypted code space to expose the 64-bit Chip ID. It then compares the two values. The values don't match, and the decryption of the host code and the kernel netlists is terminated.

What is claimed is:

1. A system for encrypting a high performance computing (HPC) application comprising:
an application code compiled into an executable file targeting a heterogenous computing environment, wherein the executable file runs on at least one host processor;
at least one FPGA device with designs compiled into associated FPGA netlists, wherein the netlists are targeted to the FPGA device;
a unique device identifier, wherein the unique device identifier is a manufacturer Chip ID associated with the FPGA device;
a License Manager utility, wherein the License Manager utility is provided via a Licensor to a Licensee to read the unique device identifier from the FPGA device;
an AES encryption algorithm using a Cyclic Block Chaining (CBC) and an Initialization Vector (IV); and
a Board Support Package (BSP), wherein the unique device identifier is embedded within the Board Support Package and is accessible to the host processor on every execution via the Board Support Package.

2. The system of claim 1, wherein the Board Support Package is Open Computing Language (OpenCL) compliant.

3. The system of claim 1, wherein the AES algorithm uses a 256-bit key.

4. The system of claim 1, wherein the IV is 128-bits.

5. The system of claim 3, wherein the AES key is randomly generated, stored, and maintained by the Licensor.

6. The system of claim 4, wherein the IV is randomly generated, stored, and maintained by the Licensor.

7. The system of claim 3, wherein the AES key rolls over with every update of the application code.

8. The system of claim 4, wherein the IV rolls over with every update of the application code.

9. The system of claim 1, wherein the unique device identifier is 64 bits.

10. A method for encrypting a HPC application, the method comprising:
reading a unique device identifier, wherein the unique device identifier is a manufacturer Chip ID from a FPGA device read via a License Manager utility;
concatenating FPGA netlists, an executable code, and the unique device identifier into the HPC application via a Licensor; and
encrypting the HPC application via an AES Cyclic Block Chaining (CBC) algorithm and an Initialization Vector (IV).

11. The method of claim 10, wherein an application programming interface (API) is used for a host to read the unique device identifier embedded within a Board Support Package.

12. The method of claim 10, wherein the AES algorithm uses a 256-bit key, and wherein the AES key is hard coded into the License Manager utility to encrypt.

13. The method of claim 10, wherein the AES algorithm uses a 128-bit IV, and wherein the IV is hard coded into the License Manager utility to encrypt.

14. The method of claim 10, wherein the AES algorithm uses a 256-bit key obtained by the License Manager utility from the Licensor via a web interface with a secure communication protocol.

15. The method of claim 10, wherein the AES algorithm uses a 128-bit IV obtained by the License Manager utility from the Licensor via a web interface with a secure communication protocol.

16. The method of claim 14, wherein the AES Key is randomly generated, stored, and maintained by the Licensor.

17. The method of claim 15, wherein the IV is randomly generated, stored, maintained by the Licensor.

18. The method of claim 14, wherein the AES Key rolls over with every update of the executable code.

19. The method of claim 15 wherein the IV rolls over with every update of the executable code.

20. The method of claim 13, wherein the unique device identifier is 64 bits.

21. The method of claim 10, wherein the unique device identifier, the FPGA netlists, and the executable code are concatenated in an arranged sequence of the unique device identifier, the FPGA netlists, and the executable code, and wherein the arranged sequence is encrypted as an executable file.

22. A system for decrypting a HPC application comprising:
an application code compiled into an executable file targeting a heterogenous computing environment, wherein the executable file runs on at least one host processor;
at least one FPGA device with a design compiled into associated FPGA netlists, wherein the netlists are targeted to the FPGA device;
a unique device identifier, wherein the unique device identifier is a manufacturer Chip ID associated with the FPGA device;
a License Manager utility, wherein the License Manager utility is provided via a Licensor to a Licensee to read the unique device identifier from the FPGA device;
an AES encryption algorithm using a Cyclic Block Chaining (CBC) and an Initialization Vector (IV); and
a Board Support Package (BSP), wherein the unique device identifier is embedded within the Board Support Package and is accessible to the host processor on every execution via the Board Support Package.

23. The system of claim 22, wherein the Board Support Package is OpenCL compliant.

24. The system of claim 22, wherein the AES algorithm uses a 256-bit key, and wherein the key is hard coded into the License Manager utility to encrypt.

25. The system of claim 22, wherein the AES algorithm uses a 256-bit key obtained via the License Manager utility from the Licensor via a web interface with a secure communication protocol.

26. The system of claim 22, wherein the AES algorithm uses a 128-bit IV obtained by the License Manager utility from the Licensor via a web interface with a secure communication protocol.

27. The system of claim 22, wherein the AES algorithm uses a 128-bit IV, and wherein the IV is hard coded into the License Manager utility to encrypt.

28. The system of claim 24, wherein the AES Key is randomly generated, stored, and maintained by the Licensor.

29. The system of claim 26, wherein the IV is randomly generated, stored, and maintained by the Licensor.

30. The system of claim 24, wherein the AES Key rolls over with every update of the application code.

31. The system of claim 26, wherein the IV rolls over with every update of the application code.

32. The system of claim 22, wherein the unique device identifier is 64 bits.

33. A method for decrypting a HPC application comprising:
reading a first unique device identifier embedded within a BSP via a License Manager utility that is launched by a Licensee, wherein the first unique device identifier is a manufacturer Chip ID from a FPGA device;
decrypting a second unique device identifier from the HPC application via the License Manager utility with a static AES key and an IV; and
comparing the first unique device identifier against the second unique device identifier via the License Manager utility.

34. The method of claim 33, wherein a positive match of the first and the second unique device identifier proceeds with decrypting the remainder of the HPC application, outputting a decrypted executable file of a Host code netlist and a Kernel Code netlist, and launching the executable file.

35. The method of claim 33, wherein a negative match of the first and the second unique device identifier terminates a decryption process.
